(19) United States
(12) Patent Application Publication
(10) Pub. No.: US 2016/0133095 A1
(43) Pub. Date: May 12, 2016

(54) SYSTEM AND METHOD FOR PLAYING AN ONLINE GAME OF CHANCE

(71) Applicant: HUMMUS INTERACTIVE LTD., Tortola (VG)

(72) Inventor: Igor SHRAIBMAN, Kiev (UA)

(21) Appl. No.: 14/894,346

(22) PCT Filed: Apr. 28, 2015
(86) PCT No.: PCT/GB2015/051243

§ 371 Date: Nov. 26, 2015

Related U.S. Application Data
(60) Provisional application No. 61/984,880, filed on Apr. 28, 2014.

(51) Int. Cl. G07F 17/32

(52) U.S. Cl. CPC G07F 17/3276; G07F 17/3286; G07F 17/3211

(57) ABSTRACT

A game of chance for a first player and a second player implementable on a computing device. The game includes a presenter to present the game to the first player and the second player and where the first player reveals a first set of winning symbols associated with a first monetary prize and the second player reveals a second set of winning symbols associated with a second monetary prize and where a combined set of the first winning symbols and the second set of winning symbols is associated with a third monetary prize and where the third monetary prize is greater than the sum of the first monetary prize and the second monetary prize. The game also includes a social trader to coordinate social interaction between the first player and the second player to negotiate a distribution of the third monetary prize between the first player and the second player.

### CROSS-REFERENCE TO RELATED APPLICATIONS

This application claims benefit from U.S. Provisional Patent Application No. 61/984,880, filed 28 Apr. 2014, which is hereby incorporated in its entirety by reference.

### FIELD OF THE INVENTION

The present invention relates to online gaming and games of chance in particular.

### BACKGROUND OF THE INVENTION

Online multiplayer gaming—in-game user interaction, directly influencing the outcome of the game has become very popular with the onset of the internet and the different devices available for play such as personal computers, tablets, mobile communication units, interactive televisions etc.

Many online games use a multiplayer mechanics such as card table games, massively multiplayer online games (MMORPG), which blend the genres of role-playing video games and massively multiplayer online games, zero sum multiplayer games such as skill-based online games—chess, checkers, tic-tac-toe etc. and duel-style fighting games or fantasy sport games.

Multiplayer games play a large role in the gambling world with the appearance of on-line poker and the diversity of dice-based games (such as backgammon, etc.), where gamblers compete against other players and not against different variants of random number generation systems as on-line casinos games (Black Jack, Roulette) and lotteries.

With the rise of social networks, game developers have started to adjust single-player games for use in these networks, with the purpose of gaining the multiplayer achievements by mimicking the in-game player-to-player interaction by providing so called “social features” (such as tell-a-friend, leaderboards, tournaments, etc.'). Game developers have also attempted to adapt single-player games to parallel symmetric games—e.g. compete in asynchronous parallel games with historical attempts. But, these “social games” are far from real multiplayer user experience and term “social” defines the usage ecosystem and not a game-play nature.

### SUMMARY

There is provided, in accordance with an embodiment of the present invention, a game of chance for a first player and a second player implementable on a computing device. The game includes a presenter to present the game to the first player and the second player and where the first player reveals a first set of winning symbols associated with a first monetary prize and the second player reveals a second set of winning symbols associated with a second monetary prize and where a combined set of the first winning symbols and the second set of winning symbols is associated with a third monetary prize and where the third monetary prize is greater than the sum of the first monetary prize and the second monetary prize. The game also includes a social trader to coordinate social interaction between the first player and the second player to negotiate a distribution of the third monetary prize between the first player and the second player.

Moreover, in accordance with a preferred embodiment of the present invention, the game also includes a game monitor to monitor play between the first player and the second player, a results processor to calculate the combined set of the first winning symbols and the second set winning symbols and the associated third monetary prize according to an associated prize table and a winnings distributer to pay out the third monetary prize according to the distribution.

Further, in accordance with a preferred embodiment of the present invention, the game is presented as a board sub divided into units and where the shape of the board is at least one of square, rectangular, pyramidal and circular.

Still further, in accordance with a preferred embodiment of the present invention, the size of the board is determined by the size of the platform used to present it.

Additionally, in accordance with a preferred embodiment of the present invention, the platform is at least one of: a personal computer, a mobile communication device, a tablet and an interactive television.

Moreover, in accordance with a preferred embodiment of the present invention, the shape of the winning symbols is at least one of a letter, a number, a shape and sign.

Further, in accordance with a preferred embodiment of the present invention, the winning symbols are at least one of equally distributed between the player one and the player two and divided between the player one and the player two according to a pre-defined agreement.

Still further, in accordance with a preferred embodiment of the present invention, the prize table is pre-determined by a game operator based on at least one of: game rules, game patterns, budget, desired payout, statistical and probability analysis and local laws.

Additionally, in accordance with a preferred embodiment of the present invention, the monetary prize is at least one of: real money, e-money, virtual money and cryptocurrency.

Moreover, in accordance with a preferred embodiment of the present invention, the social trader includes an interface to present a distribution of the combined winnings and to enable interaction for negotiations for an individual payout for the first player and the second player and a negotiation coordinator to coordinate the negotiations between the first player and the second player.

There is provided, in accordance with an embodiment of the present invention, a social trader implementable on a computing device. The social trader includes an interface to present a distribution of combined winnings for two players for a game of chance and to enable interaction for negotiations for an individual payout for the two players for the game of chance where the combined winnings is based on a pre-determined prize table and a negotiation coordinator to coordinate the negotiations between the two players.

There is provided, in accordance with an embodiment of the present invention, a multi-player game of chance. The game includes a single player game of chance where a winning payout is according to a pre-determined prize table and a social trader to enable two players to jointly play the single-player game of chance where the distribution of the winnings payout between the two players is negotiable.

Moreover, in accordance with a preferred embodiment of the present invention, the social trader includes an interface to present the distribution of the winnings payout and to enable interaction for negotiations for an individual payout for each of the two players and a negotiation coordinator to coordinate the negotiations between the two players.

There is provided, in accordance with an embodiment of the present invention, a method implementable on a computing device. The method includes presenting a game of chance to a first player and a second player where the first player reveals a first set of winning symbols associated with a first monetary prize and the second player reveals a second set of winning symbols associated with a second monetary prize and where a combined set of the first winning symbols and the second set of winning symbols is associated with a third monetary prize and where the third monetary prize is greater than the sum of the first monetary prize and the second monetary prize. The method also includes coordinating social interaction between the first player and the second player to negotiate a distribution of the third monetary prize between the first player and the second player.

Moreover, in accordance with a preferred embodiment of the present invention, the method also includes monitoring play between the first player and the second player, calculating the combined set of the first winning symbols and the second set winning symbols and the associated third monetary prize according to an associated prize table; and paying out the third monetary prize according to the distribution.

Further, in accordance with a preferred embodiment of the present invention, the game is presented as board sub divided into units and wherein the shape of the board is at least one of square, rectangular, pyramidal and circular.

Still further, in accordance with a preferred embodiment of the present invention, the size of the board is determined by the size of the platform used to present it.

Additionally, in accordance with a preferred embodiment of the present invention, the platform is at least one of: a personal computer, a mobile communication device, a tablet and an interactive television.

Moreover, in accordance with a preferred embodiment of the present invention, the shape of the winning symbols is at least one of a letter, a number, a shape and sign.

Further, in accordance with a preferred embodiment of the present invention, the winning symbols are at least one of equally distributed between the player one and the player two and divided between the player one and the player two according to a pre-defined agreement.

Still further, in accordance with a preferred embodiment of the present invention, the prize table is pre-determined by a game operator based on at least one of: game rules, game patterns, budget, desired payout, statistical and probability analysis and local laws.

Additionally, in accordance with a preferred embodiment of the present invention, the monetary prize is at least one of: real money, e-money, virtual money and cryptocurrency.

Moreover, in accordance with a preferred embodiment of the present invention, the coordinating includes presenting a distribution of the combined winnings and enabling interaction for negotiations for an individual payout for the first player and the second player and coordinating the negotiations between the first player and the second player.

There is provided, in accordance with an embodiment of the present invention, a method implementable on a computing device. The method includes presenting a distribution of combined winnings for two players for a game of chance and enabling interaction for negotiations for an individual payout for the two players for the game of chance where the combined winnings is based on a pre-determined prize table and coordinating the negotiations between the two players.

There is provided, in accordance with an embodiment of the present invention, a method implementable on a computing device. The method includes a single player game of chance where a winning payout is according to a pre-determined prize table and enabling two players to jointly play the single-player game of chance where the distribution of the winnings payout between the two players is negotiable.

Moreover, in accordance with a preferred embodiment of the present invention, the enabling includes presenting the distribution of the winnings payout and facilitating interaction for negotiations for an individual payout for each of the two players and coordinating the negotiations between the two players.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a schematic illustration of a multiplayer game of chance, constructed and operative in accordance with a preferred embodiment of the present invention;

FIG. 1B is an example prize table for the game of chance of FIG. 1A;

FIGS. 2A and 2B are schematic illustrations of different shaped game boards and winning symbols for the game of chance of FIG. 1A;

FIG. 2C is an example of tables of combinations of individual winnings for different combinations of winning symbols for the game of chance of FIG. 1, constructed and operative in accordance with a preferred embodiment of the present invention;

FIGS. 3A and 3B are a schematic illustrations of an example game of the game of chance of FIG. 1;

FIG. 4 is a schematic illustration of a system for a prize payout trader for a game of chance of FIG. 1, constructed and operative in accordance with a preferred embodiment of the present invention; and

FIG. 5 is a schematic illustration of a dealing mechanism for the game of chance of FIG. 1, constructed and operative in accordance with a preferred embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that a multiplayer feature as an additional layer to a regular game of no direct player-to-player interaction where players play against different variants of randomly generated number systems, which may affect the game outcome, may make a game-play more interesting, competitive, addictive and fun. It will be appreciated that these randomly generated number systems may contain more than one game structure elements such as symbols as described in more detail herein below. A full or partial match of the combination of the player to the winning combination of these elements may determine the game outcome. In these games, the elements or symbols may be equally divided or distributed otherwise between the players according to an agreement between them.

Applicants have further realized that the “social games” that are being developed by game designers as described herein above are far from the real multiplayer user experience and term “social” defines the usage ecosystem only and not the game-play nature.

It will be appreciated that for games of chance with no direct player-to-player in-gaming competition, the core gaming mechanics i.e. choosing the right game elements to match a winning combination either manually or as desired by the player (such as in a lottery) or automatically/assigned by the system (such as in pre-defined bingo cards), do not provide any social interaction between players in the form of a direct in-game social experience.

It will be further appreciated that there are some game-related forms of social interaction such as lottery syndicates and game guilds, but they do not provide any in-game social experience and do not affect the game outcome.

Applicants have realized that a way of obtaining true social in-game interaction between players in such games as described herein above is to add a direct social interaction between the players in order to directly affect the outcome of the game for each individual player. For example, two players may play a game typically designed to be a single player game and may share the winnings payout for the game. For example, both players may buy a scratch card together and take it in turns to uncover a symbol or in another example may play bingo together using the same card.

It will be appreciated that the game outcome (prize fund) table may contain both a total (maximum) prize for the game as well as an individual payout prize for each player, the amount of which is may be based on the exact match of personal game elements/symbols revealed by a player to an individual winning combination. Therefore for 2 players playing with the same scratch card, for each number of correct symbols uncovered, it may be determined how much each individual player has won.

It will also be appreciated that the total game symbols in such a game may be equally distributed between the players or may be divided between the players according to a predefined agreement. Such games may include but are not limited to on-line Bingo, Keno, Slots, lottery, scratch cards etc.

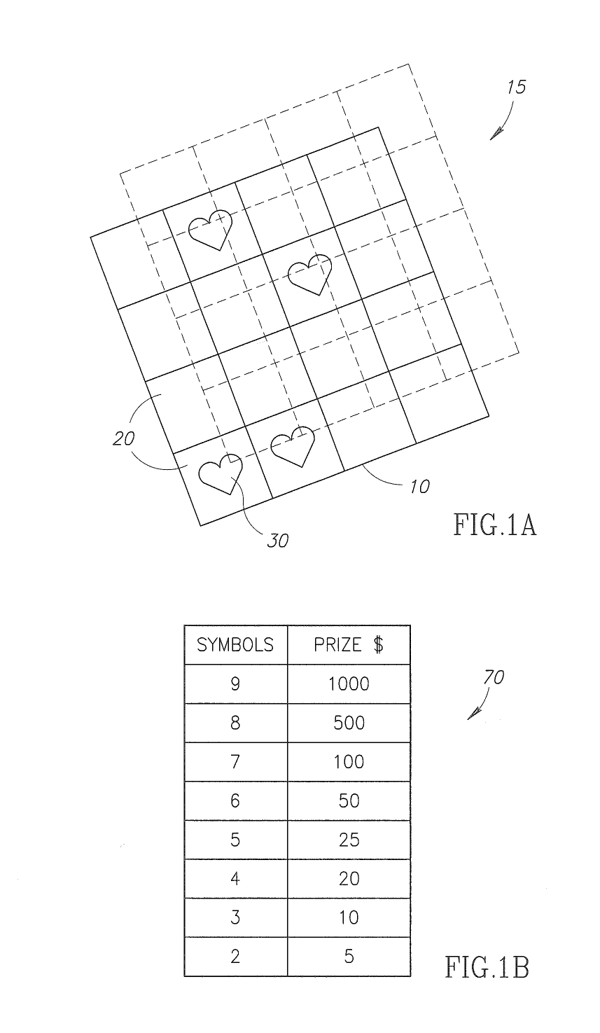

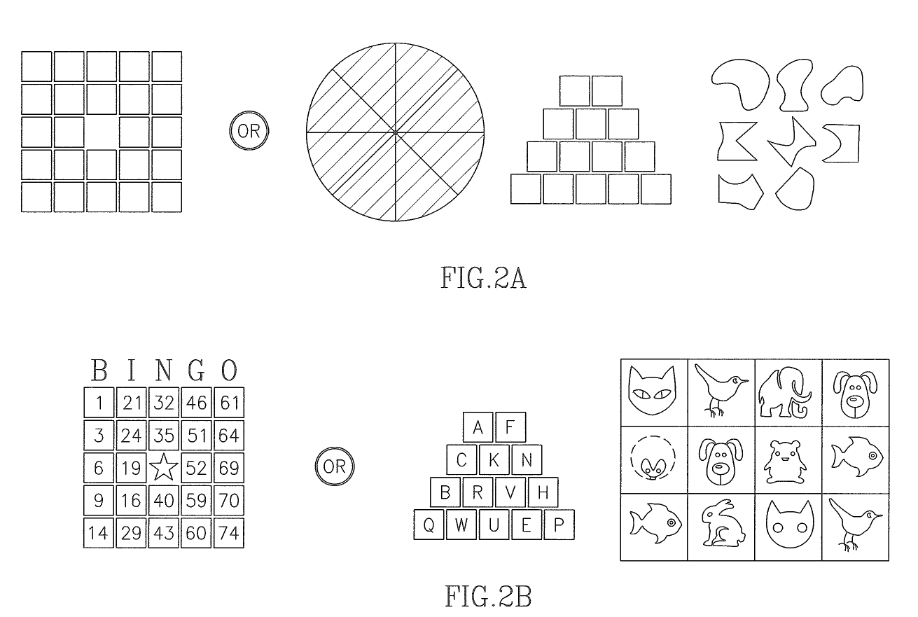

Reference is now made to FIG. 1A which illustrates a game board 10 for a typical game of chance 15 between 2 players. Game board 10 may comprise multiple game units 20. Some game units 20 may further comprise a winning symbol 30 as described in further detail herein below. It will be appreciated that game of chance 15 may be likened to a scratch card with virtual covering 50 to cover all the game units 20 at the start of the game. At the end of each game played, when all game units 20 have been uncovered and all winning symbols were released, each player may have a separate amount of winning symbols 30 that they have uncovered. For example for a board 10 of 16 game units 20, with overall 9 winning symbols, player 1 may uncover 4 symbols and player 2 may uncover 5 symbols.

It will be further appreciated that, in the case of an even number of players, board 10 may only have an even number of game units 20. Therefore each player may always play game 15 with an equal number of units 20.

Reference is now made to FIG. 1B which illustrates an example prize table 70 for game of chance 15, listing potential winnings according to winning symbols 30. As can be seen for the example in FIG. 1A of a board 10 of 16 units 20, the prize a player may receive for a game with 9 winning symbols 30 is $1000 with 8 winning symbols 30 is $500 . . . etc.

It will be further appreciated that if the number and position of winning symbols 30 is generated randomly, the probability of winning all the symbols by one player only—statistically is very low. In the games 20 where the number of winning symbols exceeds the number of personal symbols for a player, winning all the symbols for only one player is impossible.

Therefore for game 15 as described herein above, both players may take it in turns to uncover symbols 30. For example, for the game 15 being played there may be a total of 9 winning symbols 30. It will be appreciated that a win of 9 symbols according to table 70 may be a win of $1000.

It will be appreciated that same concept may also apply to a game of chance 15 where the game units are not covered i.e. are open and where game symbols and winning patterns are known to players in advance, but the winning combination of specific game is unknown before the end of the game—such as bingo, keno, slots, lottery, etc.'

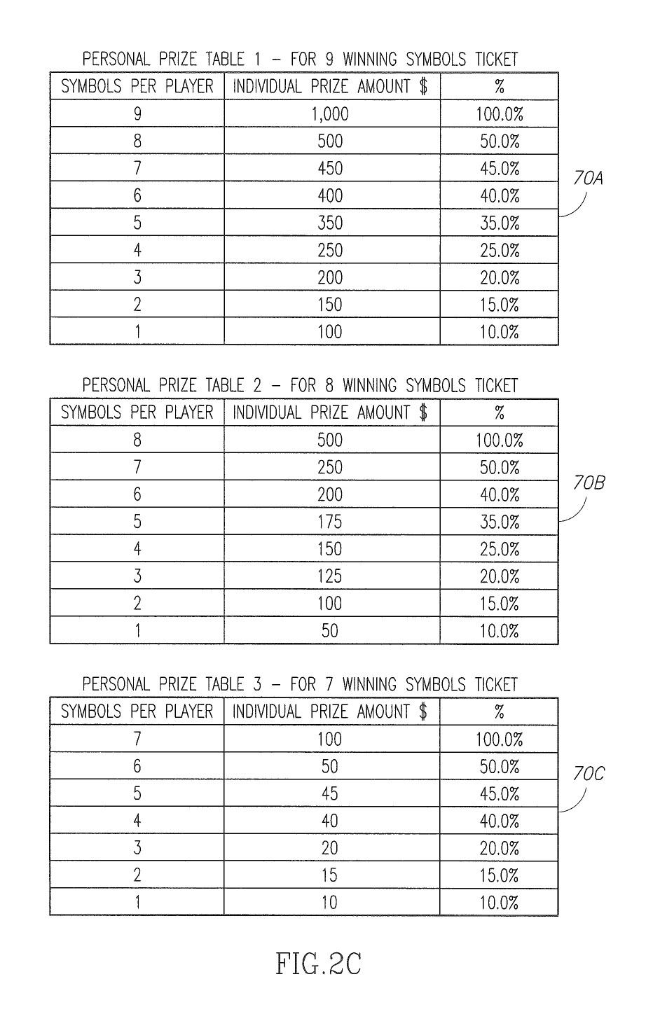

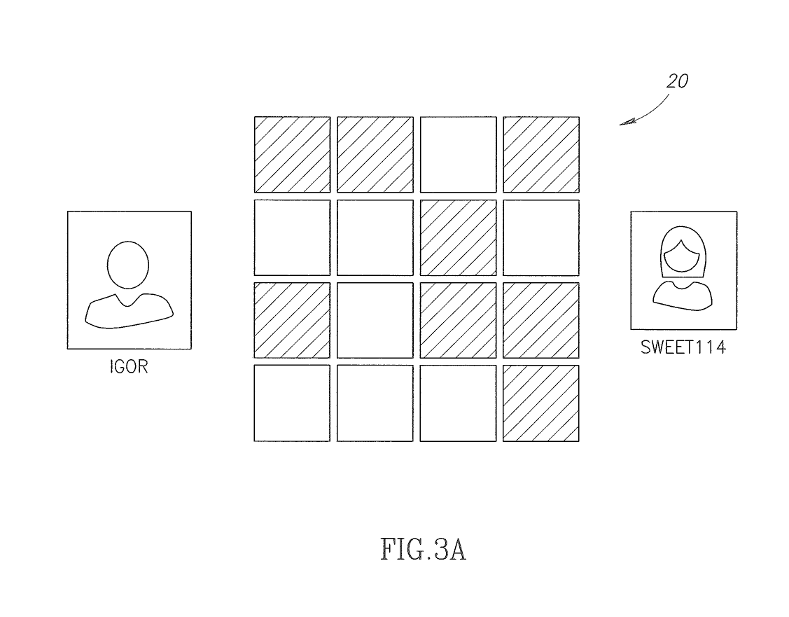

Reference is now made to FIG. 2A which illustrates different examples of game board 20. It will be appreciated that board 20 may have different shapes i.e. may not necessarily be square, but may also be round or pyramidal. It will be further appreciated that each winning symbol 30 that appears on board 20 may also take on different forms such as letters, numbers, shapes, signs etc. such as are illustrated in FIG. 2B to which reference is now made.

It will be appreciated that game of chance 15 may be played on different platforms such as personal computers, mobile communication devices, tablets, interactive televisions etc.

It will be further appreciated that two players may purchase a ticket together from the pertinent game operator via the desired platform, equally sharing the cost. The players may decide to buy a ticket for a particular game 15 according to a potential winning prize, the price of the ticket or by the game design. The maximum prize available plus any other price lists may be presented to the players via the pertinent user interface. It will be appreciated that tickets may be purchased using any existing or future legal monetary means such as real money, e-money, virtual money, cryptocurrency, a promo code (for a promotional game) etc. Payouts from winning games may also be using real money, virtual money, bonus games, etc. It will be appreciated that the more expensive the game, the higher the potential prize winnings.

It will be appreciated that for each game 15 there may be multiple associated prize tables 70 as discussed herein above, each prize table detailing the total prize win available and each individual prize for each number of total symbols 30 for the game 15 as is illustrated in FIG. 2C to which reference is now made. FIG. 2C shows three different prize tables (70A, 70B and 70C) for a single game 15. Prize table 70A shows an individual prize distribution for 9 total winning symbols, table 70B shows an individual prize distribution for 8 total winning symbols and 70B shows an individual prize distribution for 7 total winning symbols.

It will be further appreciated that the prize fund distribution scheme may be built in such a way so that the individual winnings of each player are not distributed linearly. Therefore the allocation of individual (per player) winning symbols 30 does not exceed a maximum individual payout of 60% of the top prize as is illustrated in the % column for tables 70A, 70B and 70C. Therefore the sum of the individual winnings may always be less than the top prize. Thus for the example discussed herein above where player 1 uncovers 3 symbols and player 2 uncovers 4 symbols, according to table 70C which is the prize table for uncovering 7 symbols, player 1 wins $20, player 2 wins $40 and the combined win of 7 uncovered symbols wins $100. It will be further appreciated that for a game with no winning symbols 30 there may be no prize payout and for a game with a single winning symbol the combined payout may be the same as the individual payout.

It will be appreciated that if player 1 and player 2 had uncovered 8 total symbols, then the payout would be according to table 70B and if they had uncovered 9 total symbols then the payout would be according to table 70A. It will be further appreciated that other tables 70 may also exist for 6, total symbols, 5 total symbols etc.

It will be further appreciated that prize tables 70 may be determined by the game operator and may be based on game rules, game patterns, budget, desired payout and statistical and probability analysis also incorporating factors such as local laws pertinent to a county pertaining to the minimum payback required for such a game. The size of board 10 (i.e. the number of game units 20 appearing) may also take into account the platform being used. For a mobile phone application, with a smaller screen, a small board 10 with lesser units 20 may be desirable whereas a board 10 to be played using a 50 inch interactive television screen may be large etc.

The players may decide at this point, to collect their individual winnings and retire from the game.

It will also be appreciated that typically, the more expensive the game 15 the higher the prize payout. It will be further appreciated that a single player may increase his potential prize payout by buying a more expensive game by sharing the costs with a second player

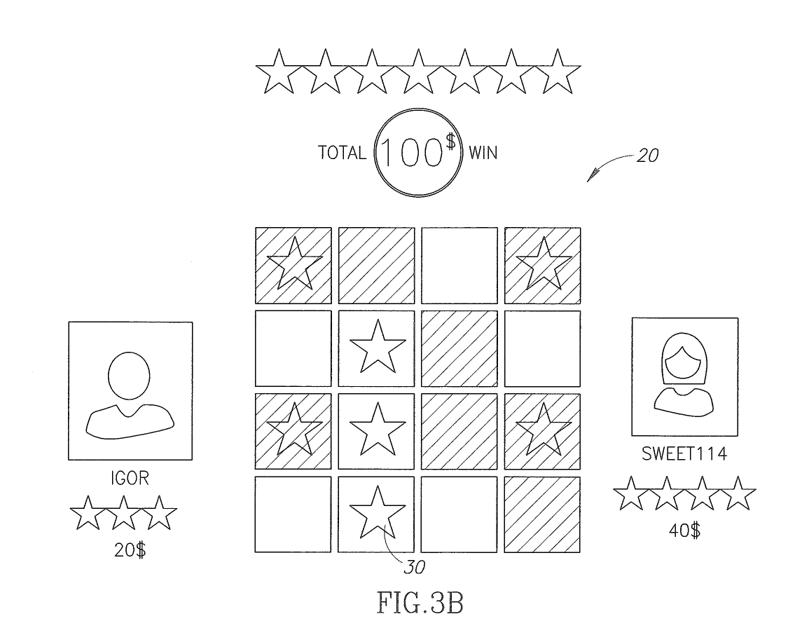

Reference is now made to FIGS. 3A and 3B which illustrate a random game 15 between 2 players with user names Igor and Sweet114. FIG. 3A illustrates the start of the game and FIG. 3B illustrates the outcome.

As can be seen, in FIG. 3B, the game 15 contains 7 winning symbols with a potential total payout $100 (as per prize table 70C in FIG. 2C). Igor and Sweet114 uncover all 7 winning symbols and can therefore win the prize of $100. Igor has uncovered 3 winning symbols while Sweet114 has uncovered 4 winning symbols. According to table 70C the individual prize payout is $20 for Igor and $40 for Sweet114. At this stage, Igor and Sweet114 may decide to end the game and take their individual payouts or may decide to share the $100 between them.

In accordance with an embodiment of the present invention, Igor and Sweet114 may need to interact directly to coordinate how to distribute the $100 between them. It will be appreciated that if they decide to pool resources and share the prize equally, each player will win $50 each, more than they would have won individually (Igor has 3 winning symbols which is worth $20 and Sweet114 has 4 winning symbols which is worth $40). In order to do this, they come to an agreement to share the $100 prize on mutually beneficial terms and conditions. It will be further appreciated that Sweet114 may wish to take a larger percentage of the money since she uncovered more winning symbols than Igor.

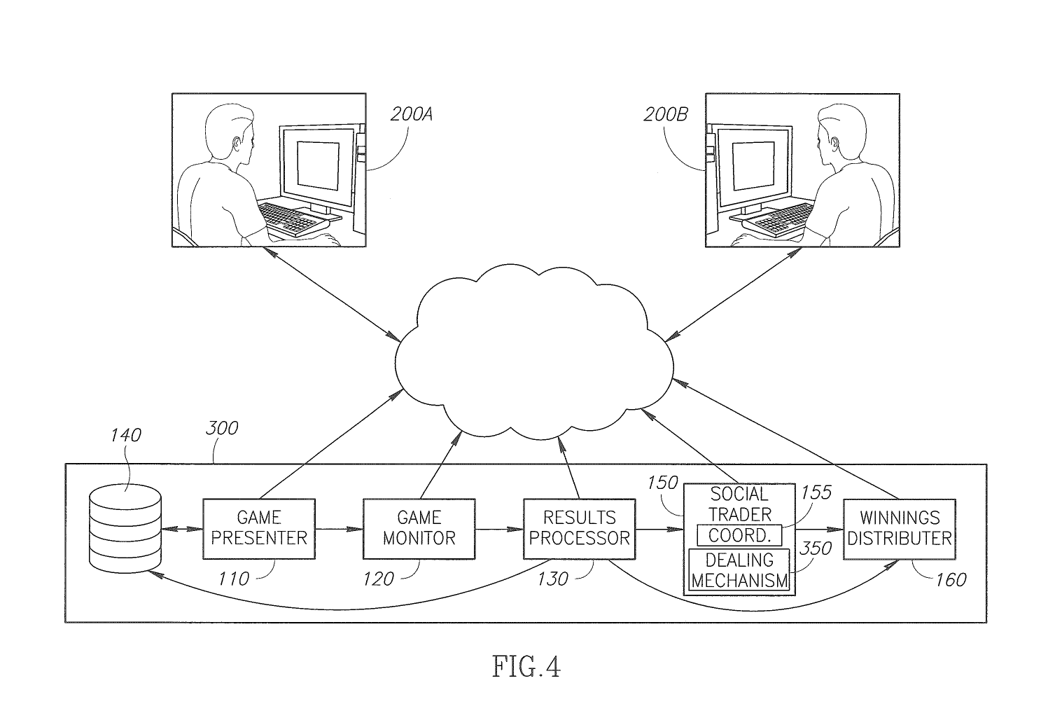

Reference is now made to FIG. 4 which illustrates a system 100 for a prize payout trader for a game of chance between two players in accordance with an embodiment of the present invention. System 100 comprises a game presenter 110, a game monitor, 120, a result processor 130, a database 140, a social trader 150 and a winnings distributer 160. Database 140 may store games 15 such the pre-determined or random number generated game boards 10 as discussed herein above in relation to FIG. 1 together with their associated prize tables 70. Social trader 150 may further comprise a dealing mechanism 350 to present to the players the total winnings per player and may allow players to input requests and a negotiation coordinator 155 to coordinate the input to social trader 150 as discussed in more detail herein below.

It will be appreciated that system 100 may be installed on a server 300 and presented on clients 200A and 200B via a suitable user interface. It will be further appreciated that each player may access game 15 via clients 200A and 200B. In an alternative embodiment, each player may access game 15 via a shared client 200.

Game presenter 110 may present to the players a suitable game 15 (with board 10) retrieved from database 140 which matches the requirements of the player (design of board, game per highest price etc.)

Game monitor 120 may monitor play as both players take it in turns to play game 15 (for example to uncover the game units 20 from the example in FIG. 1) and may inform results processor 130 once the game has come to an end—when all game units 20 have been revealed as well as how many winning symbols 30 have been revealed.

Once game 15 has come to an end (i.e. once board 10 has been totally uncovered and all the winning symbols 30 revealed), results processor 130 may present to the players the final prize according to the number of winning symbols 30 and the associated prize table 70C for the game 15 that has just been played and may then request instructions as to how to proceed. As discussed herein above, each player may decide to cash in their winnings individually (according to the individual prize win) and leave the game or may decide to pool resources. If they decide to terminate the game, results processor 130 may instruct winnings distributer 160 to pay out the pertinent prizes. If they decide to continue, result processor 130 may instruct trader 150 accordingly as to the total number of winning symbols 30 in the game.

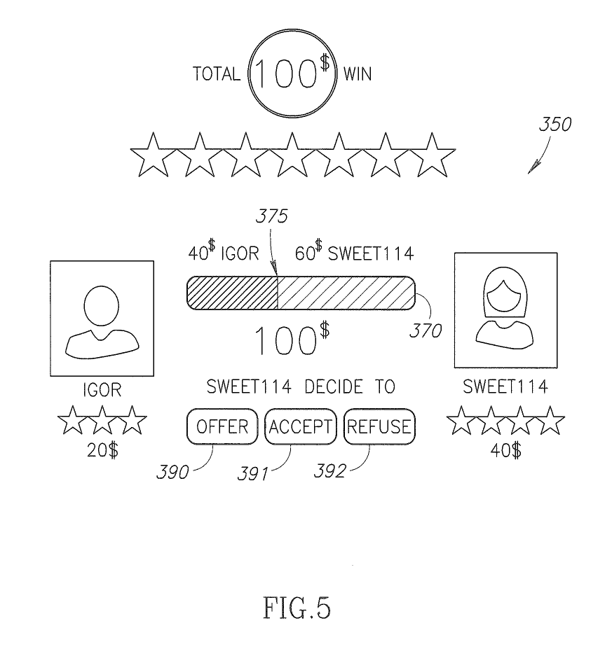

Social trader 150 may present to each player a dealing mechanism 350 as is illustrated in FIG. 5 to which reference is now made. Dealing mechanism 350 may provide a visual representation of the total prize metrics either by presenting actual values or a percentage ratio in the form of a moveable scroll bar 370. Slider 370 may have a default arrow 375 in the center dividing it 50%—50% or per the ratio of the winning symbols 30 as revealed by each of the two players. Dealing mechanism 350 may further comprise a button 390 labelled “offer”, a button 391 labelled “accept” and a button 392 labelled “refuse” or with any other similar meanings.

Social trader 150 may then request from the player with the smaller amount of winning symbols 30 (in our example Igor) to make an offer to the other player (Sweet114) using slider 370. For example Igor might offer to share the potential $100 winnings 40% to him and 60% to Sweet114 giving himself winnings of $40 and Sweet114 $60, both sums higher than each player would have won individually.

Sweet114 may agree/disagree using the pertinent button. If she agrees, social trader 50 may instruct winnings distributer 160 to make the pertinent payout to the players.

If Sweet114 does not agree to the division of the winnings, she may move arrow 375 across slider 370 and propose a different ratio.

It will be appreciated that in this way, both players may negotiate with each other until an agreement is reached between them. It will be further appreciated that there may be no limit to the time taken to reach a decision or to the number of negotiations made. Once a deal has been agreed upon by both players, button 391 is pressed and winnings distributor 160 is instructed to make the relevant payouts.

Therefore direct player-to-player in-game social interaction may occur in the form of a mutually beneficial trade-off between players in order to achieve a higher payout from a single game of chance benefiting both players and enriching the game-play with true multiplayer features.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Unless specifically stated otherwise, as apparent from the /preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.)

1. A game of chance with no direct player-to player competition for a first player and a second player implementable on a computing device, said game comprising:
a presenter to present said game to said first player and said second player wherein said first player reveals a first set of winning symbols associated with a first monetary prize and said second player reveals a second set of winning symbols associated with a second monetary prize and
wherein a combined set of said first winning symbols and said second set of winning symbols is associated with a third monetary prize and wherein said third monetary prize is greater than the sum of said first monetary prize and said second monetary prize; and
a social trader to coordinate social interaction between said first player and said second player to negotiate a distribution of said third monetary prize between said first player and said second player.

2. The game according to claim 1 and also comprising:
a game monitor to monitor play between said first player and said second player;
a results processor to calculate said combined set of said first winning symbols and said second set winning symbols and said associated third monetary prize according to an associated prize table; and
a winnings distributer to pay out said third monetary prize according to said distribution.

3. The game according to claim 1 and wherein said game is presented as a board sub divided into units and wherein the shape of said board is at least one of square, rectangular, pyramidal and circular.

4. The game according to claim 2 and wherein the size of said board is determined by the size of the platform used to present it.

5. The game according to claim 4 and wherein said platform is at least one of:
a personal computer, a mobile communication device, a tablet and an interactive television.

6. The game according to claim 1 and wherein the shape of said winning symbols is at least one of a letter, a number, a shape and sign.

7. The game according to claim 1 and wherein said winning symbols are at least one of equally distributed between said player one and said player two and divided between said player one and said player two according to a pre-defined agreement.

8. The game according to claim 2 and wherein said prize table is pre-determined by a game operator based on at least one of: game rules, game patterns, budget, desired payout, statistical and probability analysis and local laws.

9. The game according to claim 1 and wherein said monetary prize is at least one of: real money, e-money, virtual money and cryptocurrency.

10. The game according to claim 1 and wherein said social trader comprises:
an interface to present a distribution of said combined winnings and to enable interaction for negotiations for an individual payout for said first player and said second player; and
a negotiation coordinator to coordinate said negotiations between said first player and said second player.

11. A social trader implementable on a computing device, said social trader comprising:
an interface to present a distribution of combined winnings for two players for a game of chance with no direct player-to player competition and to enable interaction for negotiations for an individual payout for said two players for said game of chance, wherein said combined winnings is based on a pre-determined prize table; and
a negotiation coordinator to coordinate said negotiations between said two players.

12. A multi-player game of chance, said game comprising:
a single player game of chance wherein a winning payout is according to a pre-determined prize table; and
a social trader to enable two players to jointly play said single-player game of chance wherein the distribution of said winnings payout between said two players is negotiable.

13. The multi-player game of chance according to claim 12 and wherein said social trader comprises:
an interface to present said distribution of said winnings payout and to enable interaction for negotiations for an individual payout for each of said two players; and
a negotiation coordinator to coordinate said negotiations between said two players.

14. A method implementable on a computing device, said game comprising:
presenting a game of chance with no direct player-to player competition to a first player and a second player wherein said first player reveals a first set of winning symbols associated with a first monetary prize and said second player reveals a second set of winning symbols associated with a second monetary prize; and
wherein a combined set of said first winning symbols and said second set of winning symbols is associated with a third monetary prize and wherein said third monetary prize is greater than the sum of said first monetary prize and said second monetary prize; and
coordinating social interaction between said first player and said second player to negotiate a distribution of said third monetary prize between said first player and said second player.

15. The method according to claim 14 and also comprising:
monitoring play between said first player and said second player;
calculating said combined set of said first winning symbols and said second set winning symbols and said associated third monetary prize according to an associated prize table; and
paying out said third monetary prize according to said distribution.

16. The method according to claim 14 and wherein said game is presented as a board sub divided into units and wherein the shape of said board is at least one of square, rectangular, pyramidal and circular.

17. The method according to claim 16 and wherein the size of said board is determined by the size of the platform used to present it.

18. The method according to claim 17 and wherein said platform is at least one of: a personal computer, a mobile communication device, a tablet and an interactive television.

19. The method according to claim 14 and wherein the shape of said winning symbols is at least one of a letter, a number, a shape and sign.

20. The method according to claim 14 and wherein said winning symbols are at least one of equally distributed between said player one and said player two and divided between said player one and said player two according to a pre-defined agreement.

21. The method according to claim 15 and wherein said prize table is pre-determined by a game operator based on at least one of: game rules, game patterns, budget, desired payout, statistical and probability analysis and local laws.

22. The method according to claim 14 and wherein said monetary prize is at least one of: real money, e-money, virtual money and cryptocurrency.

23. The method according to claim 14 and wherein said coordinating comprises:
presenting a distribution of said combined winnings and enabling interaction for negotiations for an individual payout for said first player and said second player; and
coordinating said negotiations between said first player and said second player.

24. A method implementable on a computing device, said method comprising:
presenting a distribution of combined winnings for two players for a game of chance with no direct player-to player competition and enabling interaction for negotiations for an individual payout for said two players for said game of chance, wherein said combined winnings is based on a pre-determined prize table; and
coordinating said negotiations between said two players.

25. A method implementable on a computing device, said method comprising:
a single-player game of chance wherein a winning payout is according to a pre-determined prize table; and
enabling two players to jointly play said single-player game of chance wherein the distribution of said winnings payout between said two players is negotiable.

26. The method according to claim 25 and wherein said enabling comprises:
presenting said distribution of said winnings payout and facilitating interaction for negotiations for an individual payout for each of said two players; and
coordinating said negotiations between said two players.
